(19) United States
(12) Patent Application Publication
(10) Pub. No.: US 2012/0308137 A1
(43) Pub. Date: Dec. 6, 2012

(54) IMAGE PROCESSING APPARATUS, IMAGE PROCESSING METHOD, AND PROGRAM

(75) Inventor: Hiroki Hamasaki, Kanagawa (JP)

(73) Assignee: SONY CORPORATION, Tokyo (JP)

(21) Appl. No.: 13/483,428

(22) Filed: May 30, 2012

(30) Foreign Application Priority Data
Jun. 6, 2011 (JP) 2011-126404

(51) Int. Cl. G06K 9/00

(52) U.S. Cl. 382/181

(57) ABSTRACT

An image processing apparatus that performs image processing to an image signal constituted of a plurality of images, including: a determination unit configured to determine whether or not an appearance pattern in which the number of repeats representing the number of sequences of the same image appears among the plurality of images constituting the image signal is a predetermined regular pattern for displaying the image signal; and an image processing unit configured to perform the image processing to the image signal in accordance with a determination result of the determination unit.

### BACKGROUND

The present disclosure relates to an image processing apparatus, an image processing method, and a program, and more particularly to an image processing apparatus, an image processing method, and a program that are capable of improving image quality of an image signal generated for edit, for example.

There is, for example, frame interpolation processing for interpolating a new frame into a moving image including a plurality of frames (or fields) and improving a frame rate (see Japanese Patent Application Laid-Open No. 2007-288681, for example).

According to the frame interpolation processing, since the new frame between the frames constituting the moving image is interpolated, an object on each frame can move smoothly.

Meanwhile, the image signal representing the moving image mainly includes an image signal generated for display (hereinafter referred to as an image signal for display) and an image signal generated for edit (hereinafter referred to as an image signal for edit).

As shown in FIG. 1A, the image signal for display is generated so that the moving image includes a plurality of different frames. Moreover, for example, as shown in FIG. 1B, since a judder (unsmooth motion) occurring in a movie film is generated, the same frame is repeated three times and two times alternately as the number of repeats which causes the same frame to appear sequentially.

According to the frame interpolation processing, when the moving image as shown in FIG. 1A is subjected to the frame interpolation, it is possible to make the movement of the object on the frame smoother.

Moreover, for example, when the moving image as shown in FIG. 1B is subjected to the frame interpolation, it is possible to make the movement of the object on the frame smoother while maintaining the original judder.

Herein, as shown in FIG. 1C, the image signal for edit includes repeat patterns of four times, two times, two times, and two times as the number of repeats. Moreover, for example, as shown in FIG. 1D, the number of repeats includes repeat patterns of five times, three times, and two times.

Alternatively, for example, in a so-called 3-dimensional (3D) moving image, the image signal for edit includes repeat patterns of two times, one time, one time, and one time as the number of repeats of the frame recognized by a user's left eye and repeat patterns of two times, one time, one time, and one time as the number of repeats of the frame recognized by the user's right eye.

### SUMMARY

The image signal for edit is configured as shown in FIG. 1C to FIG. 1E depending on convenience of editing, efficiency in compression coding and the like, so that the display of the frame included in the image signal is not taken into consideration.

Accordingly, when the frame included in the image signal for edit is displayed, an irregular (unnatural) judder is generated.

Therefore, it is generally desirable that works such as editing be performed to the image signal for edit and the edited image signal be converted into the image signal for display for making a broadcast and the like.

However, at present, the image signal for edit is not converted into the image signal for display and is broadcasted in many cases due to the reasons such as costs and man-hours.

Therefore, for example, when the image signal for edit is subjected to the frame interpolation processing in a television receiver and the like which receive the image signal to be broadcasted, it may be impossible to obtain the effect of making the movement of the object on the frame smoother.

Moreover, since the image signal for edit is subjected to the frame interpolation processing, the irregular judder is emphasized, so that it may be impossible to see the moving image clearly.

Furthermore, for example, also in a case where the image signal for edit is subjected to noise reduction, interlace progressive (IP) conversion and the like performed to the image signal for display, it may be impossible to obtain a desired effect as with the frame interpolation processing, so that the moving image is difficult to be seen clearly.

The present disclosure has been conceived in view of the above-described circumstances so as to improve image quality of the image signal generated for edit.

According to an embodiment of the present disclosure, there is provided an image processing apparatus that performs image processing to an image signal constituted of a plurality of images, including: a determination unit configured to determine whether or not an appearance pattern in which the number of repeats representing the number of sequences of the same image appears among the plurality of images constituting the image signal is a predetermined regular pattern for displaying the image signal; and an image processing unit configured to perform the image processing to the image signal in accordance with a determination result of the determination unit.

The image processing apparatus may further include a conversion unit configured to convert, in response to a determination result of the determination unit that the appearance pattern is a pattern different from the regular pattern, a first image signal having the different pattern into a second image signal having the regular pattern in which the image processing unit may perform the image processing for the regular pattern to the second image signal.

The image processing apparatus may further include a detection unit configured to detect a timing signal representing timings at which the same image appears sequentially among the plurality of images constituting the second image signal, and an adjustment unit configured to adjust the timing signal and change intervals between the timings to equal intervals, in which the image processing unit may perform, based on the adjusted timing signal, the image processing for generating a third image signal constituted of the plurality of different images from the second image signal.

The adjustment unit may adjust the timing signal and change, to the equal intervals, the intervals between the timings generated within a reproduction time for reproducing the second image signal.

The conversion unit may convert the first image signal into the second image signal in accordance with a conversion rule based on the appearance pattern.

The image processing unit may perform, as the image processing, at least one of IP conversion processing of converting an interlaced image into a progressive image, noise reduction processing of reducing noise generated in the image, resolution creation processing of converting an image resolution into a higher resolution, and interpolation processing of interpolating a new image to the image signal.

According to an embodiment of the present disclosure, there is provided an image processing method of an image processing apparatus that performs image processing to an image signal constituted of a plurality of images, the method including: by the image processing apparatus, determining whether or not an appearance pattern in which the number of repeats representing the number of sequences of the same image appears among the plurality of images constituting the image signal is a predetermined regular pattern for displaying the image signal; and performing the image processing to the image signal in accordance with a determination result of the determining.

According to an embodiment of the present disclosure, there is provided a program that causes a computer of an image processing apparatus that performs image processing to an image signal constituted of a plurality of images to function as: a determination unit configured to determine whether or not an appearance pattern in which the number of repeats representing the number of sequences of the same image appears among the plurality of images constituting the image signal is a predetermined regular pattern for displaying the image signal; and an image processing unit configured to perform the image processing to the image signal in accordance with a determination result of the determination unit.

According to the embodiments of the present disclosure, it is determined whether or not the appearance pattern in which the number of repeats representing the number of sequences of the same image appears among the plurality of images constituting the image signal is the predetermined regular pattern for displaying the image signal, and the image processing is performed to the image signal in accordance with the determination result.

According to the embodiments of the present disclosure, it is possible to improve image quality of the image signal generated for edit.

These and other objects, features and advantages of the present disclosure will become more apparent in light of the following detailed description of best mode embodiments thereof, as illustrated in the accompanying drawings.

### BRIEF DESCRIPTION OF DRAWINGS

FIGS. 1A to 1E are diagrams showing an example of an image signal for display and an image signal for edit;

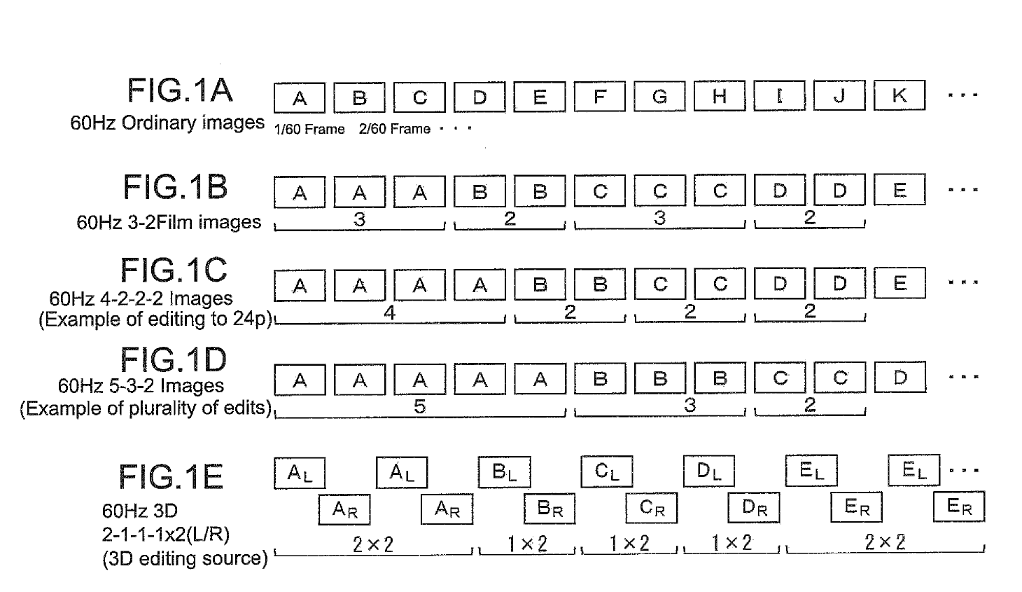

FIG. 2 is a block diagram showing a configuration example of an image processing apparatus according to a first embodiment;

FIG. 3 is a diagram showing details of processing performed by a sequence determination unit;

FIG. 4 is a flowchart for explaining first image processing;

FIG. 5 is a block diagram showing another configuration example of the image processing apparatus in FIG. 2;

FIG. 6 is a block diagram showing a configuration example of an image processing apparatus according to a second embodiment;

FIG. 7 is a first diagram for explaining a conversion method for converting a regular sequence into an irregular sequence;

FIG. 8 is a second diagram for explaining a conversion method for converting the regular sequence into the irregular sequence;

FIG. 9 is a third diagram for explaining a conversion method for converting the regular sequence into the irregular sequence;

FIG. 10 is a fourth diagram for explaining a conversion method for converting the regular sequence into the irregular sequence;

FIG. 11 is a flowchart for explaining second image processing;

FIG. 12 is a block diagram showing an example of the image processing apparatus according to a third embodiment;

FIG. 13 is a diagram showing an example of processing performed by a conversion unit and a frame interpolation unit in FIG. 12;

FIG. 14 is a diagram showing an example of a judder changed by the processing performed by the conversion unit and the frame interpolation unit in FIG. 12;

FIG. 15 is a diagram showing another example of the processing performed by the conversion unit and the frame interpolation unit in FIG. 12;

FIG. 16 is a diagram showing a further example of the processing performed by the conversion unit and the frame interpolation unit in FIG. 12;

FIG. 17 is a flowchart for explaining third image processing; and

FIG. 18 is a block diagram showing a configuration example of a computer.

### DETAILED DESCRIPTION OF EMBODIMENTS

Hereinafter, embodiments for carrying out the present disclosure (hereinafter referred to as embodiments) will be described. Herein, the explanation will proceed in the following order.

1. First embodiment (example of image processing in accordance with whether or not appearance pattern of image signal to be inputted is regular sequence)

2. Second embodiment (example of converting irregular sequence into regular sequence)

3. Third embodiment (example of correcting image signal generating judder into smoothly-moving image signal)

4. Modified examples

### 1. First Embodiment

### Configuration Example of Image Processing Apparatus 21

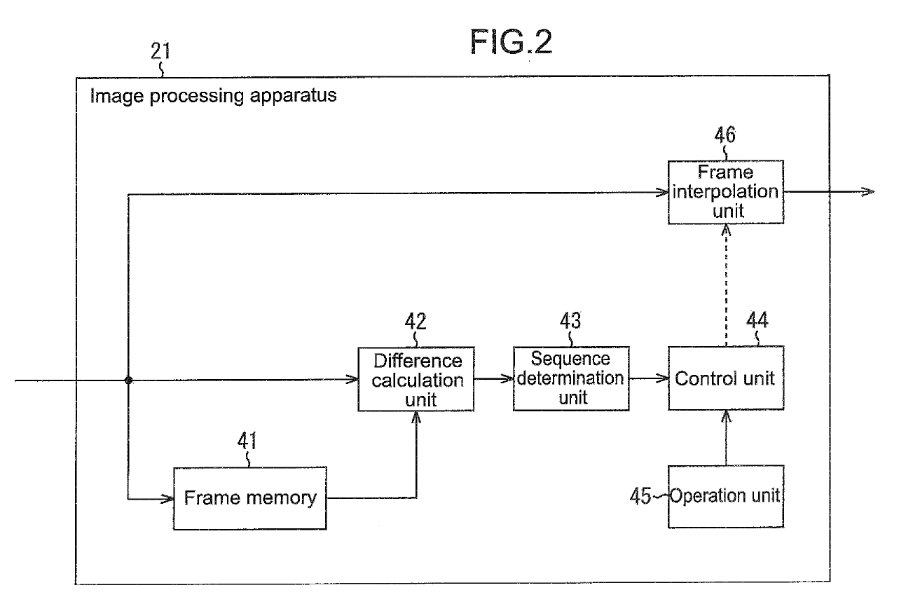

FIG. 2 shows a configuration example of an image processing apparatus 21 according to a first embodiment.

Herein, the image processing apparatus 21 detects an appearance pattern in which the number of repeats representing the number of sequences of the same frame appears among a plurality of frames (or fields) constituting an image signal to be inputted.

Moreover, the image processing apparatus 21 determines whether the detected appearance pattern is a regular sequence representing a predetermined appearance pattern for displaying or an irregular sequence representing a predetermined appearance pattern for edit.

Then, when the image processing apparatus 21 determines that the appearance pattern of the image signal to be inputted is the irregular sequence, the image processing apparatus 21 outputs the image signal to be inputted.

Moreover, when the image processing apparatus 21 determines that the appearance pattern of the image signal to be inputted is the regular sequence, the image processing apparatus 21 interpolates a new frame to each frame included in the image signal to be inputted and outputs it.

The image processing apparatus 21 includes a frame memory 41, a difference calculation unit 42, a sequence determination unit 43, a control unit 44, an operation unit 45, and a frame interpolation unit 46. The image processing apparatus 21 receives a frame n from outside as the image signal. Herein, the frame n is a frame which is inputted n-th.

The frame memory 41 receives the frame n from outside. The frame memory 41 delays the frame n from outside by one frame from the frame n supplied to the difference calculation unit 42 from outside and supplies it to the difference calculation unit 42.

That is, when the difference calculation unit 42 receives the frame n, the frame memory 41 supplies a frame n−1 previous by one frame to the difference calculation unit 42.

The difference calculation unit 42 calculates a difference D(n,n−1) between the frame n from outside and the frame n−1 from the frame memory 41 and supplies it to the sequence determination unit 43.

The sequence determination unit 43 determines whether the appearance pattern of the image signal to be inputted is the regular sequence or the irregular sequence based on the difference D(n,n−1) from the difference calculation unit 42, and supplies the determination result to the control unit 44.

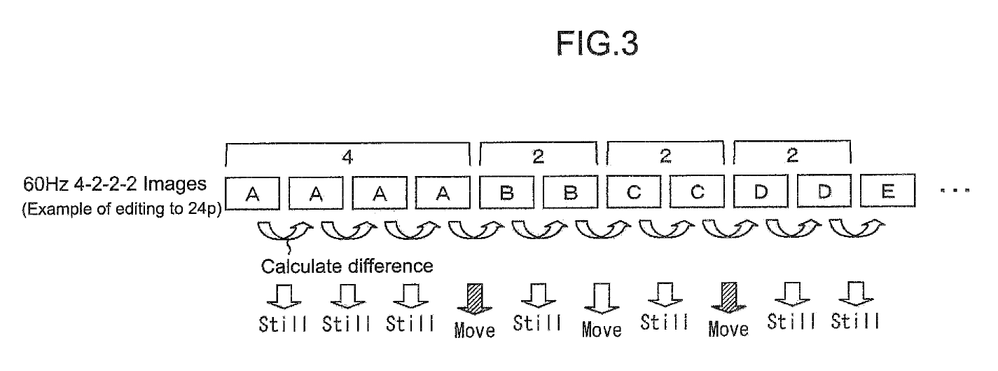

Herein, the processing performed by the sequence determination unit 43 will be later described in detail with reference to FIG. 3.

The control unit 44 controls the frame interpolation unit 46 based on the determination result from the sequence determination unit 43.

That is, for example, when the control unit 44 receives the determination result that the appearance pattern of the image signal to be inputted is the regular sequence, the control unit 44 causes the frame interpolation unit 46 to perform the frame interpolation processing. Moreover, for example, when the control unit 44 receives the determination result that the appearance pattern of the image signal to be inputted is the irregular sequence, the control unit 44 controls the frame interpolation unit 46 not to perform the frame interpolation processing.

Moreover, for example, the control unit 44 controls the frame memory 41, the difference calculation unit 42, the sequence determination unit 43, and the frame interpolation unit 46 in response to the operation signal from the operation unit 45.

The operation unit 45 includes, for example, operation buttons and the like and is operated by the user. Then, the operation unit 45 supplies a corresponding operation signal to the control unit 44 in accordance with the operation by the user.

The frame interpolation unit 46 receives the frame n from outside. The frame interpolation unit 46 interpolates the new frame between the frame n and the frame n−1 to be inputted and outputs the frame in accordance with the control of the control unit 44, for example. Moreover, for example, the frame interpolation unit 46 outputs the frame n to be inputted in accordance with the control of the control unit 44.

### Details of Processing Performed by Sequence Determination Unit 43

Next, FIG. 3 shows details of processing performed by the sequence determination unit 43.

FIG. 3 shows an example of 4-2-2-2 irregular sequences representing appearance patterns of four sequences of the same frame A, two sequences of the same frame B, two sequences of the same frame C, and two sequences of the same frame D.

The sequence determination unit 43 detects whether or not the frame n and the frame n−1 are the same frames in accordance with whether or not (an absolute value of) the difference D(n,n−1) from the difference calculation unit 42 is less than a predetermined threshold.

That is, for example, when the frame n and the frame n−1 are the same frames, the difference D(n,n−1) from the difference calculation unit 42 is (almost) zero and is less than the predetermined threshold. In this case, the sequence determination unit 43 detects that the frame n and the frame n−1 are the same frames.

Moreover, for example, when the frame n and the frame n−1 are different frames, the difference D(n,n−1) from the difference calculation unit 42 is a relatively large value and is greater than or equal to the threshold. In this case, the sequence determination unit 43 detects that the frame n and the frame n−1 are different frames.

The sequence determination unit 43 calculates the appearance pattern of the image signal inputted to the image processing apparatus 21 in accordance with the plurality of differences D from the difference calculation unit 42 corresponding to a combination of two different frames.

Then, the sequence determination unit 43 determines whether the calculated appearance pattern is the regular sequence or the irregular sequence and supplies the determination result to the control unit 44.

### Description of Operation of Image Processing Apparatus 21

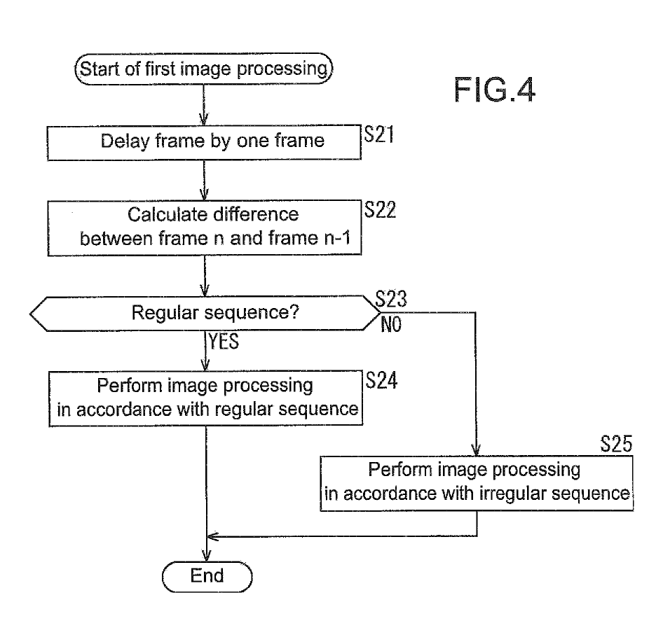

Next, with reference to the flowchart in FIG. 4, the image processing performed by the image processing apparatus 21 (hereinafter referred to as first image processing) will be described.

Herein, the first image processing is started when the image processing apparatus 21 receives the image signal from outside, for example.

In step S21, the frame memory 41 delays the frame n included in the image signal from outside by one frame from the frame n supplied to the difference calculation unit 42 from outside and supplies it to the difference calculation unit 42.

That is, when the difference calculation unit 42 receives the frame n, the frame memory 41 supplies the frame n−1 previous by one frame to the difference calculation unit 42.

In step S22, the difference calculation unit 42 calculates the difference D(n,n−1) between the frame n from outside and the frame n−1 from the frame memory 41 and supplies it to the sequence determination unit 43.

By the processing in step S21 and step S22, when the sequence determination unit 43 receives the plurality of differences D corresponding to the combination of two different frames from the difference calculation unit 42, the processing proceeds to step S23.

In step S23, the sequence determination unit 43 determines whether the appearance pattern of the image signal to be inputted is the regular sequence or the irregular sequence based on the plurality of differences D from the difference calculation unit 42.

Then, in step S23, when the sequence determination unit 43 determines that the appearance pattern of the image signal to be inputted is the regular sequence based on the plurality of differences D from the difference calculation unit 42, the sequence determination unit 43 supplies the determination result to the control unit 44 and the processing proceeds to step S24.

In step S24, the control unit 44 controls the frame interpolation unit 46 in accordance with the determination result from the sequence determination unit 43 and causes the frame interpolation unit 46 to perform image processing for the regular sequence.

That is, for example, the frame interpolation unit 46 interpolates the new frame between the frame n−1 and the frame n from outside and output it in accordance with the control of the control unit 44.

Moreover, in step S23, when the sequence determination unit 43 determines that the appearance pattern of the image signal to be inputted is the irregular sequence based on the plurality of differences D from the difference calculation unit 42, the sequence determination unit 43 supplies the determination result to the control unit 44 and the processing proceeds to step S25.

In step S25, the control unit 44 controls the frame interpolation unit 46 in accordance with the determination result from the sequence determination unit 43 and causes the frame interpolation unit 46 to perform image processing for the irregular sequence.

That is, for example, the frame interpolation unit 46 does not interpolate the new frame between the frame n−1 and the frame n from outside and outputs the frame n from outside in accordance with the control of the control unit 44. Herein, for example, the first image processing is completed when the image signal inputted to the image processing apparatus 21 is subjected to the image processing and all the frames constituting the image signal obtained by the image processing are outputted.

As described above, according to the first image processing, when the appearance pattern of the image signal to be inputted is the regular sequence, the frame is interpolated, and when the appearance pattern of the image signal to be inputted is the irregular sequence, the frame is not interpolated.

Therefore, in the first image processing, for example, when the appearance pattern of the image signal is the irregular sequence, the frame is interpolated, so that it is possible to prevent emphasis of the unnatural judder.

Moreover, for example, when the appearance pattern of the image signal is the regular sequence, the frame is interpolated, so that it is possible to make the movement of the object on the frame smoother in a reproduction time of the image signal.

Herein, in step S23, the sequence determination unit 43 performs determination processing for determining whether or not the appearance pattern of the image signal to be inputted is the regular sequence based on the plurality of differences D from the difference calculation unit 42.

In the determination processing, it is possible to improve determination accuracy and stabilize the operation by optimizing the number of the differences D used for the determination and the threshold or the like to be compared with the differences D described with reference to FIG. 3.

Moreover, for example, when the number of determinations in which it is determined that the appearance pattern of the image signal to be inputted is the regular sequence reaches a predetermined number in the determination processing, it may be ultimately determined that the appearance pattern of the image signal to be inputted is the regular sequence.

In this case as well, it is possible to improve determination accuracy and stabilize the operation by optimizing the number of the differences D used for the determination, the threshold or the like to be compared with the differences D described with reference to FIG. 3, and also the predetermined number.

Moreover, in the first embodiment, the frame interpolation is performed as the image processing to the image signal, but the image processing is not limited to this.

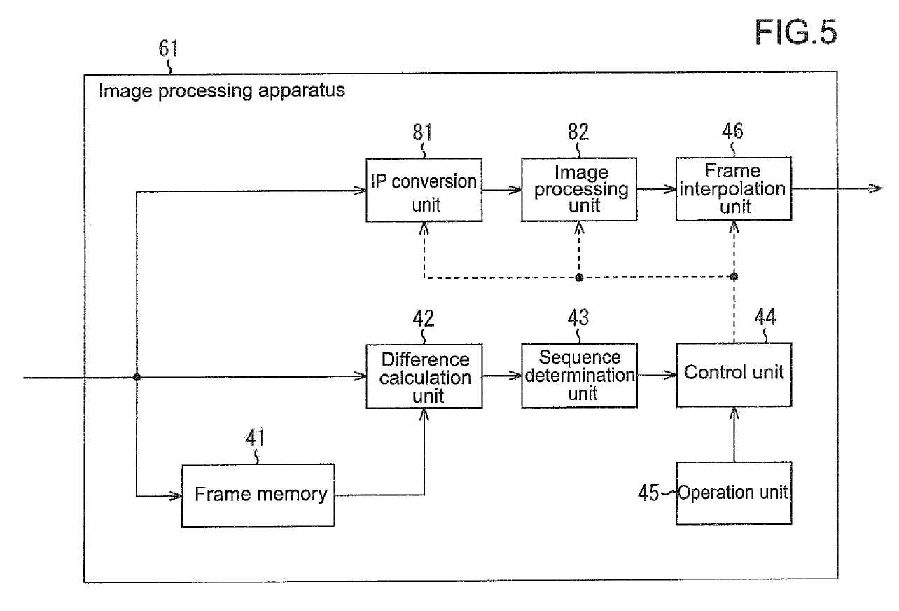

That is, for example, as with an image processing apparatus 61 shown in FIG. 5, it is possible to provide an IP conversion unit 81, an image processing unit 82 and the like in addition to the frame interpolation unit 46 and perform various processing.

FIG. 5 shows a configuration example of the image processing apparatus 61 including the IP conversion unit 81 and the image processing unit 82 in addition to the frame interpolation unit 46.

In FIG. 5, the same reference numerals are given to components configured in the same manner as the image processing apparatus 21 shown in FIG. 2, and therefore, explanation thereof will be omitted below.

That is, the image processing apparatus 61 is configured in the same manner as the image processing apparatus 21 shown in FIG. 2 except that the IP conversion unit 81 and the image processing unit 82 are newly provided.

When the appearance pattern of the image signal from outside is the regular sequence, the IP conversion unit 81 performs IP conversion to the image signal from outside in accordance with the control of the control unit 44 and supplies the image signal obtained by the IP conversion to the image processing unit 82.

Herein, the IP conversion is processing which converts an interlaced image (field) displayed in an interlaced mode into a progressive image (frame) displayed in a progressive mode.

Therefore, when the field is inputted as the image signal from outside, the IP conversion unit 81 performs the IP conversion. Herein, when the frame is inputted as the image signal from outside, the IP conversion unit 81 does not perform the IP conversion and supplies the frame to the image processing unit 82.

Moreover, when the appearance pattern of the image signal from outside is the irregular sequence (not regular sequence), the IP conversion unit 81 performs the IP conversion in which the suppression of a comb-like noise is intensified to the image signal from outside in accordance with the control of the control unit 44 and supplies the image signal obtained by the IP conversion to the image processing unit 82. This is due to the reason that when the appearance pattern of the image signal is the irregular sequence, the image signal is subjected to the IP conversion, thereby generating the comb-like noise easily.

Moreover, for example, when the appearance pattern of the image signal is the regular sequence, the IP conversion unit 81 can perform the IP conversion using the motion vector detected based on each field and when the appearance pattern of the image signal is the irregular sequence, the IP conversion unit 81 can perform the IP conversion without using the motion vector.

This is due to the reason that when the appearance pattern of the image signal is the irregular sequence, the detection accuracy of the motion vector is decreased.

Alternatively, for example, the IP conversion unit 81 may perform pull-down processing for converting (pulling-down) a first image signal of 30 frames (60 fields) per second used in a television broadcast and the like into a second image signal recorded at 24 frames per second, such as movie films, instead of the IP conversion.

In this case, for example, when the appearance pattern of the image signal to be inputted is the regular sequence, the IP conversion unit 81 performs the above-described pull-down processing and when the appearance pattern of the image signal to be inputted is the irregular sequence, the IP conversion unit 81 does not perform the above-described pull-down processing.

Moreover, for example, the IP conversion unit 81 may perform reverse pull-down processing for reverse-converting the second image signal into the first image signal, instead of the pull-down processing.

In this case as well, when the appearance pattern of the image signal to be inputted is the regular sequence, the IP conversion unit 81 performs the reverse pull-down processing and when the appearance pattern of the image signal to be inputted is the irregular sequence, the IP conversion unit 81 does not perform the reverse pull-down processing.

The image processing unit 82 performs noise reduction processing for reducing noise, resolution creation processing for converting an image signal resolution to a higher resolution, and the like to the image signal from the IP conversion unit 81.

That is, for example, the image processing unit 82 performs the noise reduction processing with the use of a different noise reduction filter and the like based on whether or not the appearance pattern of the image signal from outside is the irregular sequence.

Alternatively, for example, the image processing unit 82 may perform the noise reduction processing by dynamically changing the noise reduction filter and the like in accordance with the number of repeats in the appearance pattern.

Moreover, for example, the image processing unit 82 performs the resolution creation processing with the use of a different parameter based on whether or not the appearance pattern of the image signal from outside is the irregular sequence.

The image processing unit 82 supplies the processed image signal to the frame interpolation unit 46.

Herein, the image processing apparatus 61 performs the IP conversion processing by the IP conversion unit 81, the noise reduction processing and the resolution creation processing by the image processing unit 82, and the frame interpolation processing by the frame interpolation unit 46 and may also, for example, perform only the IP conversion processing by omitting the image processing unit 82 and the frame interpolation unit 46.

That is, for example, the image processing apparatus 61 can perform at least one of the IP conversion processing, the noise reduction processing, the resolution creation processing, and the frame interpolation processing. Herein, this also applies similarly to a second embodiment and a third embodiment discussed below.

### 2. Second Embodiment

### Configuration Example of Image Processing Apparatus 101

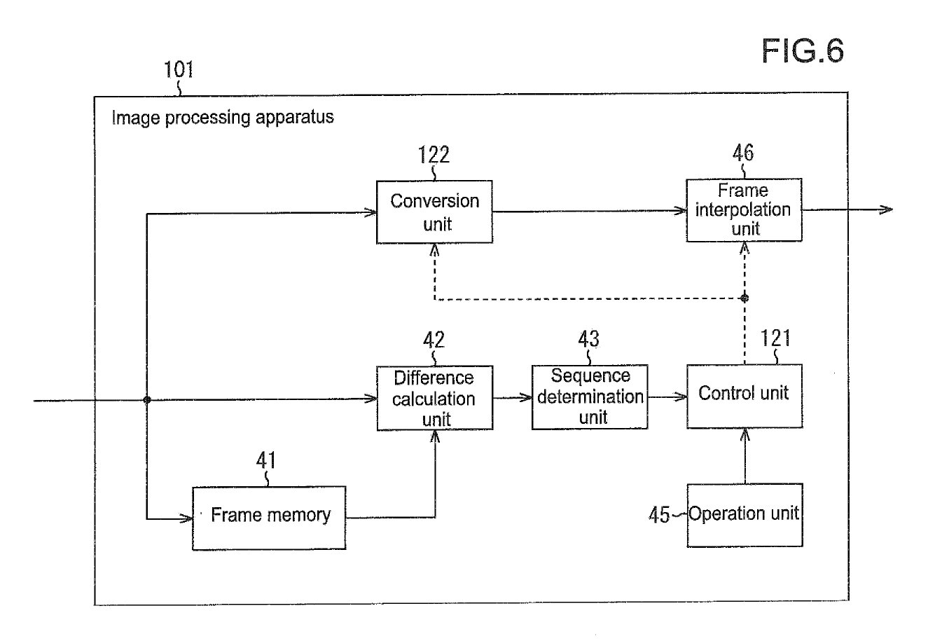

Next, FIG. 6 shows a configuration example of an image processing apparatus 101 according to the second embodiment.

Herein, in the image processing apparatus 101, the same reference numerals are given to components configured in the same manner as the image processing apparatus 21 shown in FIG. 2, and therefore, explanation thereof will be omitted below.

That is, the image processing apparatus 101 is configured in the same manner as the image processing apparatus 21 shown in FIG. 2 except that a control unit 121 is provided instead of the control unit 44 shown in FIG. 2 and also a conversion unit 122 is newly provided.

The control unit 121 controls the conversion unit 122 based on the determination result from the sequence determination unit 43.

That is, for example, when the control unit 121 receives the determination result that the appearance pattern of the image signal to be inputted is the regular sequence, the control unit 121 controls the conversion unit 122 to supply the image signal to the frame interpolation unit 46.

Moreover, for example, when the control unit 121 receives the determination result that the appearance pattern of the image signal to be inputted is the irregular sequence, the control unit 121 controls the conversion unit 122 to convert the image signal having the appearance pattern of the irregular sequence into the image signal having the appearance pattern of the regular sequence and to supply it to the frame interpolation unit 46.

Moreover, for example, the control unit 121 controls the frame interpolation unit 46 and performs the image processing for regular sequence regardless of the determination result from the sequence determination unit 43.

In this case, for example, the frame interpolation unit 46 performs the frame interpolation to the image signal of the regular sequence from the conversion unit 122 in accordance with the control of the control unit 121 and outputs the interpolated image signal.

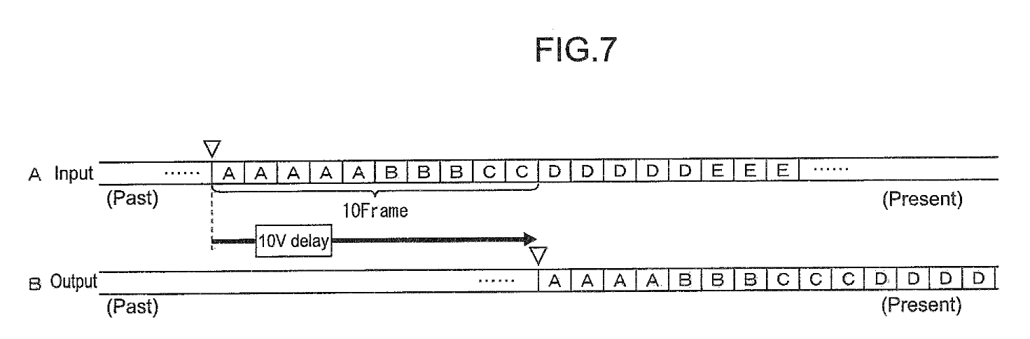

When the appearance pattern of the image signal to be inputted is the irregular sequence, the conversion unit 122 converts the image signal of the irregular sequence into the image signal of the regular sequence in accordance with the control of the control unit 121 and supplies it to the frame interpolation unit 46. Herein, the processing performed by the conversion unit 122 will be later described in detail with reference to FIG. 7 to FIG. 10.

In this case, in the image processing apparatus 101 shown in FIG. 6, it is possible to provide the IP conversion unit 81 before the conversion unit 122 and supply the IP converted image signal by the IP conversion unit 81 to the conversion unit 122, for example.

Alternatively, for example, the image processing unit 82 performing the noise reduction processing and the resolution creation processing to the image signal processed by the conversion unit 122 may be provided between the conversion unit 122 and the frame interpolation unit 46.

### First Conversion Method Performed by Conversion Unit 122

Next, FIG. 7 shows a first conversion method for which the conversion unit 122 converts the image signal of the irregular sequence into the image signal of the regular sequence and outputs it.

A of FIG. 7 shows the image signal of 5-3-2 irregular sequences representing appearance patterns 5-3-3 of five sequences of the same frame A, three sequences of the same frame B, and two sequences of the same frame C.

B of FIG. 7 shows the image signal of 4-3-3 regular sequences representing appearance patterns 4-3-3 of four sequences of the same frame A, three sequences of the same frame B, and three sequences of the same frame C.

As shown in A of FIG. 7, the conversion unit 122 causes ten frames (for example, five frames A, three frames B, and two frames C in A of FIG. 7) among a plurality of frames including the image signal from outside to store a built-in memory (not shown) in accordance with the control of the control unit 121.

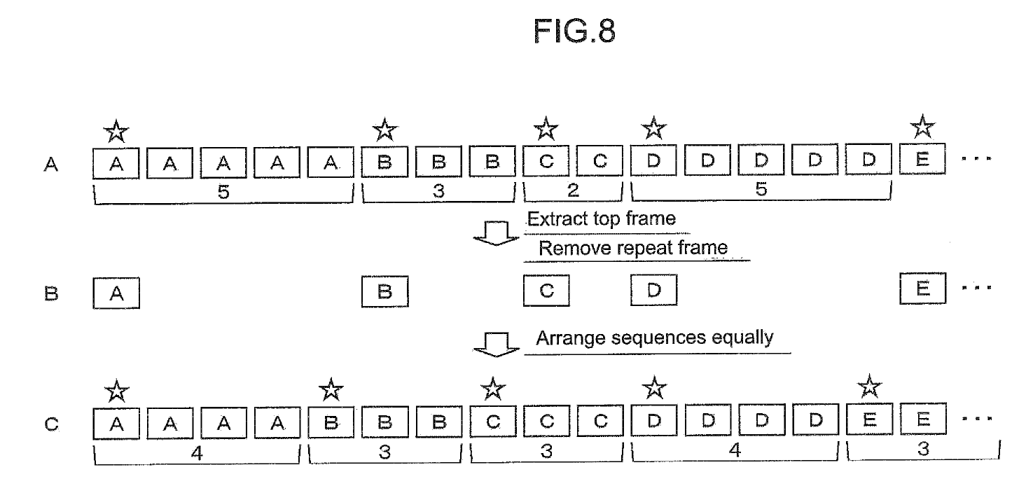

Then, as shown in B of FIG. 7, the conversion unit 122 converts the stored appearance patterns 5-3-3 of ten frames into the 4-3-3 regular sequences representing the appearance patterns 4-3-3 and outputs the converted ten frames to the frame interpolation unit 46, for example. Herein, the conversion method of the appearance pattern will be later described with reference to FIG. 8, for example.

Thus, the conversion unit 122 converts the appearance patterns 5-3-3 for every ten frames into the appearance patterns 4-3-3.

Herein, as shown in FIG. 7, the conversion unit 122 converts the image signal of the appearance patterns 5-3-2 into the image signal of the appearance patterns 4-3-3, for example.

That is, the conversion unit 122 converts to the image signal of the appearance patterns 4-3-3 similar to the appearance patterns 5-3-3 of the image signal to be inputted based on the magnitude relation of the number of repeats.

Specifically, for example, as shown in A of FIG. 7, in the image signal to be inputted, the number of repeats of the frame A (in this case, five times) is larger than the number of repeats of the frame B (in this case, three times).

Therefore, as shown in B of FIG. 7, the conversion unit 122 converts the image signal to be inputted into the image signal so that the number of repeats of the frame A (in this case, four times) is larger than the number of repeats of the frame B (in this case, three times).

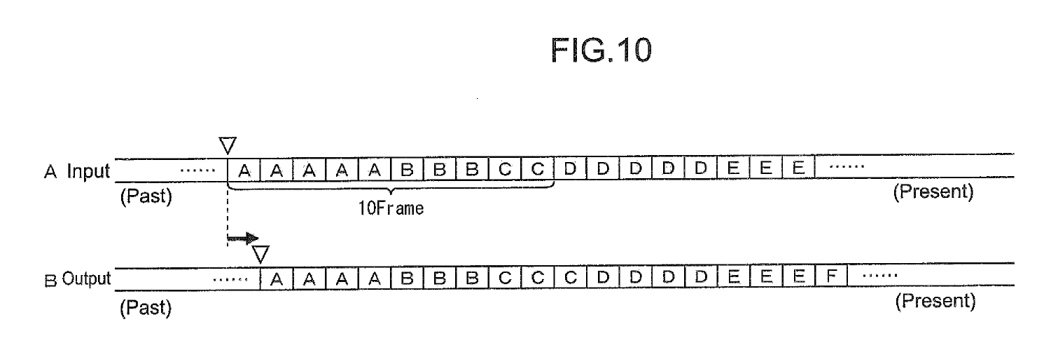

Therefore, since the conversion unit 122 converts the appearance pattern of the image to be inputted into the similar appearance pattern, it is possible to reduce a time used in conversion. This will be later described in detail with reference to FIG. 10.

Next, FIG. 8 shows an example of a case where the conversion unit 122 converts the image signal of the 5-3-2 irregular sequences into the image signal of the 4-3-3 regular sequences.

The conversion unit 122 stores the image signal of the 5-3-3 irregular sequences as shown in A of FIG. 8 into the built-in memory (not shown) in ten frame units.

That is, for example, the conversion unit 122 stores five frames A, three frames B, and two frames C shown in A of FIG. 8 into the built-in memory (not shown).

Then, for example, as shown in B of FIG. 8, the conversion unit 122 extracts the top frame A, the top frame B and the top frame C from five frames A, three frames B, and two frames C stored in the built-in memory.

As shown in C of FIG. 8, the conversion unit 122 generates four frames A based on the extracted top frame A. Likewise, the conversion unit 122 generates three frames B based on the extracted top frame B and two frames C based on the extracted top frame C.

Thus, the conversion unit 122 converts the image signal of the 5-3-3 irregular sequences as shown in A of FIG. 8 into the image signal of the 4-3-3 regular sequences in ten frame units as shown in C of FIG. 8. Then, the conversion unit 122 supplies the converted image signal of the 4-3-3 regular sequences to the frame interpolation unit 46.

Herein, the conversion unit 122 can convert not only the image signal of the 5-3-3 irregular sequences but also the image of the irregular sequence of a different appearance pattern into the image signal of the regular sequence.

That is, for example, the conversion unit 122 can convert the image signal of the 4-2-2-2 irregular sequences into the image signal of 3-2 regular sequences.

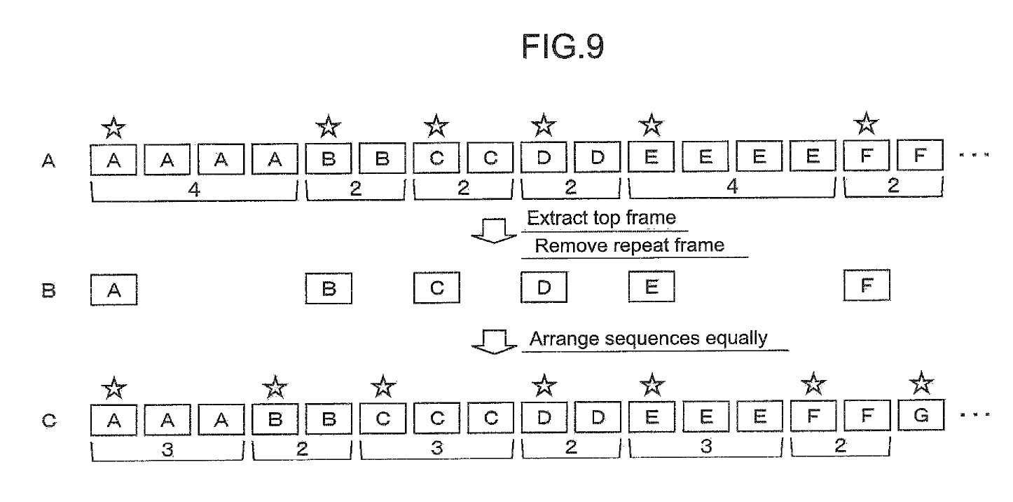

Specifically, for example, the conversion unit 122 stores the image signal of the 4-2-2-2 irregular sequences as shown in A of FIG. 9 into the built-in memory (not shown), in ten frame units.

That is, for example, the conversion unit 122 stores four frames A, two frames B, and two frames C, and two frames D shown in A of FIG. 9 into the built-in memory (not shown).

Then, for example, as shown in B of FIG. 9, the conversion unit 122 extracts the top frame A, the top frame B, the top frame C, and the top frame D from four frames A, two frames B, and two frames C, and two frames D stored in the built-in memory.

As shown in C of FIG. 9, the conversion unit 122 generates three frames A based on the extracted top frame A. Likewise, the conversion unit 122 generates two frames B based on the extracted top frame B, three frames C based on the extracted top frame C, and two frames D based on the extracted top frame D.

Thus, the conversion unit 122 converts the image signal of the 4-2-2-2 irregular sequences as shown in A of FIG. 9 into the image signal of the 3-2 regular sequences in ten frame units as shown in C of FIG. 9.

Herein, the conversion unit 122 is not limited to the first conversion method described in FIG. 7 and may also, for example, perform conversion by a second conversion method described with reference to FIG. 10.

### Second Conversion Method Performed by Conversion Unit 122

Next, FIG. 10 shows the second conversion method in which the conversion unit 122 converts the image signal of the irregular sequence into the image signal of the regular sequence and outputs it.

For example, when the control unit 121 receives, from the sequence determination unit 43, the determination result that the appearance pattern of the image signal has the 5-3-2 irregular sequences, the control unit 121 controls the conversion unit 122 to perform conversion by a conversion rule based on the 5-3-3 irregular sequences.

The conversion unit 122 receives the image signal of the 5-3-3 irregular sequences as shown in A of FIG. 10, for example.

The conversion unit 122 converts the 5-3-2 irregular sequences to be supplied from outside into the image signal of the 4-3-3 regular sequences as shown in B of FIG. 10 by using the conversion rule based on the 5-3-3 irregular sequences in accordance with the control of the control unit 121 and outputs it to the frame interpolation unit 46.

That is, for example, as shown in A of FIG. 10, when the conversion unit 122 receives the top frame among the frames (for example, frames D) whose number of repeats is five, the conversion unit 122 outputs the frame (for example, the frame C) supplied previous by one frame instead of the top frame, to the frame interpolation unit 46 in accordance with the conversion rule as shown in B of FIG. 10.

Moreover, for example, as shown in A of FIG. 10, when the conversion unit 122 receives the frame other than the top frame among the frames (for example, frames D) whose number of repeats is five, the conversion unit 122 outputs it to the frame interpolation unit 46 in accordance with the conversion rule as shown in B of FIG. 10.

Moreover, for example, as shown in A of FIG. 10, when the conversion unit 122 receives the frames (for example, frames B) whose number of repeats is three, the conversion unit 122 outputs the frames to the frame interpolation unit 46 in accordance with the conversion rule as shown in B of FIG. 10.

Moreover, for example, as shown in A of FIG. 10, when the conversion unit 122 receives the frames (for example, frames C) whose number of repeats is two, the conversion unit 122 outputs the frames to the frame interpolation unit 46 in accordance with the conversion rule as shown in B of FIG. 10.

Therefore, for example, as shown in FIG. 7, the conversion unit 122 does not need to include the built-in memory for storing ten frames, thereby preventing the delay due to the frame conversion.

Moreover, since the conversion unit 122 converts the appearance pattern of the image to be inputted into the similar appearance pattern, it is possible to convert with a simpler conversion rule in comparison with a case where an arbitrary appearance pattern which is not similar to the appearance pattern of the image to be inputted is converted, for example. Therefore, according to the second conversion rule, it is possible to further reduce a time used in conversion.

Therefore, for example, the conversion unit 122 can reliably prevent the delay due to the frame conversion in comparison with a case where the appearance pattern which is not similar to the appearance pattern of the image to be inputted is converted, for example.

### Description of Operation of Image Processing Apparatus 101

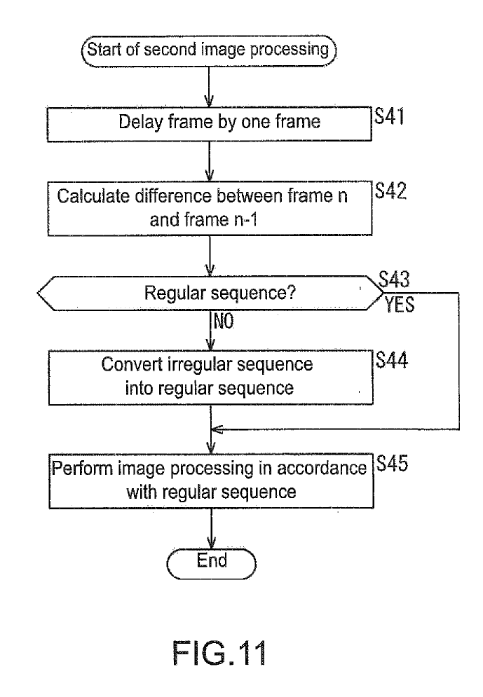

Next, with reference to the flowchart in FIG. 11, the image processing performed by the image processing apparatus 101 (hereinafter referred to as second image processing) will be described.

Herein, the second image processing is started when the image processing apparatus 101 receives the image signal from outside, for example.

In steps S41 to S43, processing similar to that of steps S21 to S23 in FIG. 4 is conducted.

Herein, in step S43, when the sequence determination unit 43 determines that the appearance pattern of the image signal to be inputted is not the regular sequence (irregular sequence) based on the plurality of differences D from the difference calculation unit 42, the sequence determination unit 43 supplies the determination result to the control unit 121.

The control unit 121 controls the conversion unit 122 and the frame interpolation unit 46 in accordance with the determination result from the sequence determination unit 43 to perform processing of steps S44 and S45.

That is, in step S44, the conversion unit 122 converts the image signal of the irregular sequence into the image signal of the regular sequence in accordance with the control of the control unit 121 and supplies it to the frame interpolation unit 46.

In step S45, the frame interpolation unit 46 performs the frame interpolation processing to the image signal from the conversion unit 122 in accordance with the control of the control unit 121.

Moreover, in step S43, when the sequence determination unit 43 determines that the appearance pattern of the image signal to be inputted is the regular sequence based on the plurality of differences D from the difference calculation unit 42, the sequence determination unit 43 supplies the determination result to the control unit 121.

The control unit 121 controls the conversion unit 122 and the frame interpolation unit 46 in accordance with the determination result from the sequence determination unit 43. The conversion unit 122 supplies the image signal of the regular sequence to the frame interpolation unit 46 in accordance with the control of the control unit 121.

Moreover, in step S45, the frame interpolation unit 46 performs the frame interpolation processing to the image signal of the regular sequence from the conversion unit 122 in accordance with the control of the control unit 121. Herein, for example, the second image processing is completed when the image signal inputted to the image processing apparatus 101 is subjected to the image processing and all the frames including the image signal obtained by the image processing are outputted.

As described above, according to the second image processing, when the appearance pattern of the image signal to be inputted is the irregular sequence, the image signal to be inputted is converted into the image signal of the regular sequence. Therefore, for example, the image signal of the irregular sequence is subjected to the frame interpolation and the like, so that it is possible to prevent emphasis of the unnatural judder.

### 3. Third Embodiment

### Configuration Example of Image Processing Apparatus 141

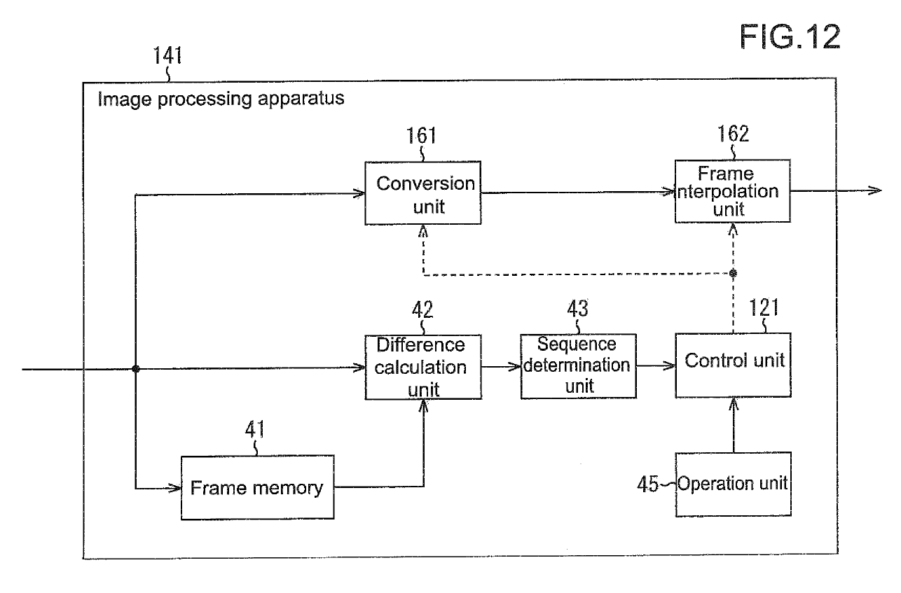

Next, FIG. 12 shows a configuration example of an image processing apparatus 141 according to a third embodiment.

Herein, in the image processing apparatus 141, the same reference numerals are given to components configured in the same manner as the image processing apparatus 101 shown in FIG. 6, and therefore, explanation thereof will be omitted below.

That is, the image processing apparatus 141 is configured in the same manner as the image processing apparatus 101 shown in FIG. 6 except that a conversion unit 161 and a frame interpolation unit 162 are provided instead of the conversion unit 122 and the frame interpolation unit 46 shown in FIG. 6.

The conversion unit 161 performs processing similar to that of the conversion unit 122. That is, for example, when the appearance pattern of the image signal from outside is the irregular sequence, the conversion unit 161 converts the image signal of the irregular sequence into the image signal of the regular sequence in accordance with the control of the control unit 121 and supplies it to the frame interpolation unit 162.

Moreover, the conversion unit 161 detects a timing signal representing a timing at which the same frame appears sequentially based on the image signal of the regular sequence outputted from the conversion unit 161.

That is, for example, the conversion unit 161 detects the top frame phase signal as the timing signal based on the image signal of the regular sequence outputted from the conversion unit 161. Herein, the top frame phase signal represents a timing at which the top frame (earliest appearing frame) appears among same sequential frames.

Then, the conversion unit 161 synchronizes the detected top frame phase signal with the image signal outputted to the frame interpolation unit 162 and supplies it to the frame interpolation unit 162.

Herein, for example, the conversion unit 161 uses low voltage differential signaling (LVDS) and the like in terms of hardware to synchronize the top frame phase signal with the image signal outputted to the frame interpolation unit 162 and supplies it to the frame interpolation unit 162.

The frame interpolation unit 162 generates and outputs the image signal having a frame rate higher than that of the image signal obtained from the conversion unit 161 based on the top frame phase signal from the conversion unit 161.

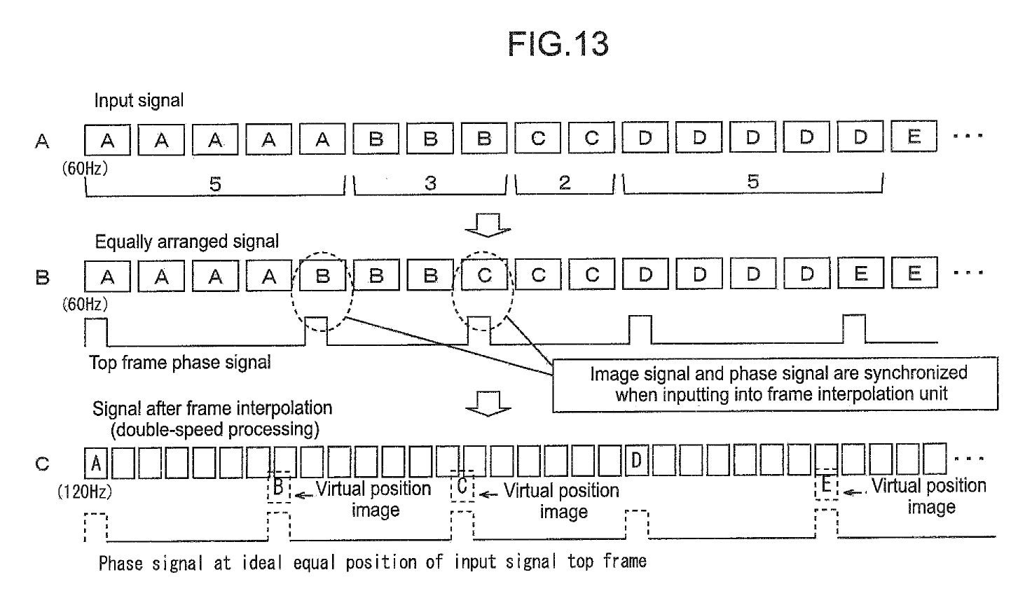

Next, FIG. 13 is an example showing processing performed by the conversion unit 161 and the frame interpolation unit 162.

A of FIG. 13 shows the image signal of the 5-3-2 irregular sequences as an example of the image signal inputted to the image processing apparatus 141.

B of FIG. 13 shows the image signal of the 4-3-3 regular sequences obtained by conversion with the conversion unit 122.

C of FIG. 13 shows the image signal having the frame rate higher than that of the image signal of the 4-3-3 regular sequences generated in response to the top frame phase signal.

For example, the conversion unit 161 converts the image signal of the 5-3-3 irregular sequences supplied from outside as shown in A of FIG. 13 into the image signal of the 4-3-3 regular sequences as shown in B of FIG. 13 and supplies it to the frame interpolation unit 162.

Moreover, for example, as shown in B of FIG. 13, the conversion unit 161 detects the top frame phase signal based on the image signal of the 4-3-3 regular sequences obtained by the conversion and supplies it to the frame interpolation unit 162 in synchronization with the signal of the 4-3-3 regular sequences.

As shown in C of FIG. 13, the frame interpolation unit 162 adjusts the top frame phase signal from the conversion unit 161 and changes projections (timings at which the top frames appear in B of FIG. 13) represented by the top frame phase signal to equal intervals.

That is, for example, the frame interpolation unit 162 adjusts the top frame phase signal from the conversion unit 161 and changes the projections represented by the top frame phase signal to the equal intervals within a range of a reproduction time for reproducing the image signal of the 4-3-3 regular sequences as shown in B of FIG. 13.

Then, the frame interpolation unit 162 determines a position of the object on each of the frames constituting the image signal newly generated by the frame interpolation and the like based on the adjusted top frame phase signal.

That is, for example, when the frame is displayed by the changed projections, the frame interpolation unit 162 determines that the position of the object on the frame corresponds to the position of the object displayed on the top frames A, B, C, D, E, . . . corresponding to the projections.

The frame interpolation unit 162 generates and outputs a new image signal including each frame on which the object is drawn at the determined position.

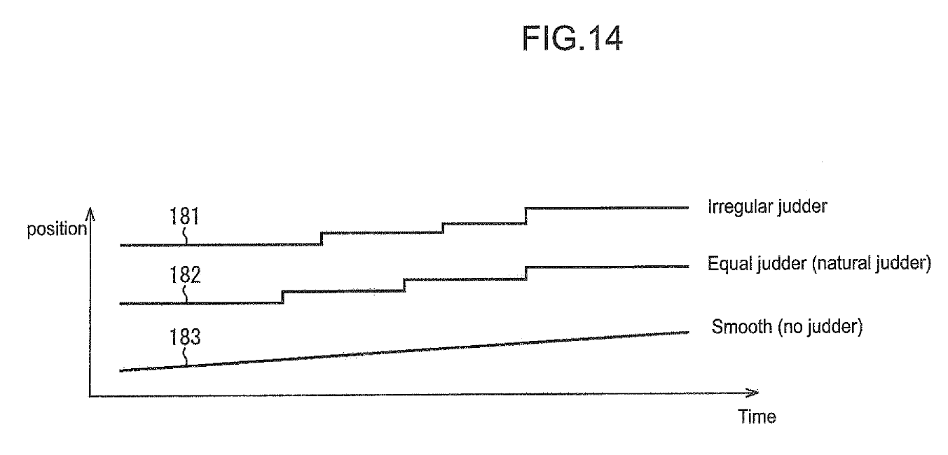

Next, FIG. 14 shows an example of the judder generated in each image signal shown in A to C of FIG. 13.

In the case of the image signal as shown in A of FIG. 13, the position of the object on the frame is irregularly changed as time passes as shown in a graph 181 of FIG. 14. This is due to the reason that the appearance pattern of the image signal shown in A of FIG. 13 is the irregular sequence.

In the case of the image signal as shown in B of FIG. 13, the position of the object on the frame is regularly changed as shown as time passes in a graph 182 of FIG. 14. This is due to the reason that the appearance pattern of the image signal shown in B of FIG. 13 is the regular sequence.

In the case of the image signal as shown in C of FIG. 13, the position of the object on the frame is smoothly changed as time passes as shown in a graph 183 of FIG. 14. This is due to the reason that the image signal shown in C of FIG. 13 is the image signal of the regular sequence constituted of the different frame.

Herein, in FIG. 13 described above, the description has been given of the case where the appearance pattern of the image signal from outside is the 5-3-3 irregular sequences. Meanwhile, also in the case where the irregular sequences in which the appearance pattern of the image signal from outside is different from the 5-3-3 irregular sequences, processing similar to that of description in FIG. 13 is conducted.

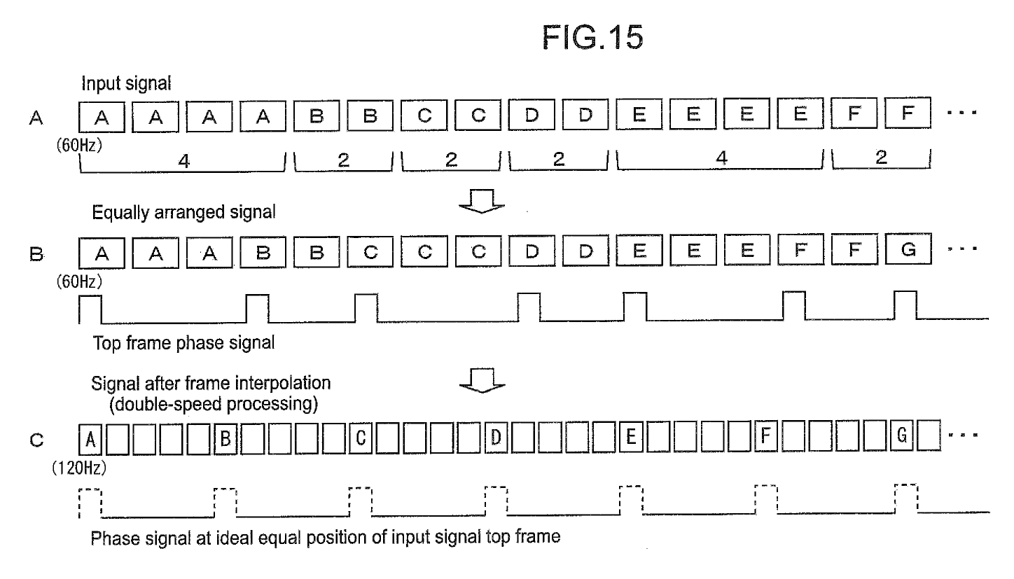

That is, for example, as shown in A of FIG. 15, when the conversion unit 161 receives the image signal of the 4-2-2-2 irregular sequences from outside, the conversion unit 161 converts it to the image signal of the 3-2 regular sequences as shown in B of FIG. 15 and detects the corresponding top frame phase signal.

Then, as shown in C of FIG. 15, the frame interpolation unit 162 changes the projections represented by the top frame phase signal from the conversion unit 161 to the equal intervals and performs the frame interpolation to the projections based on the changed top frame phase signal.

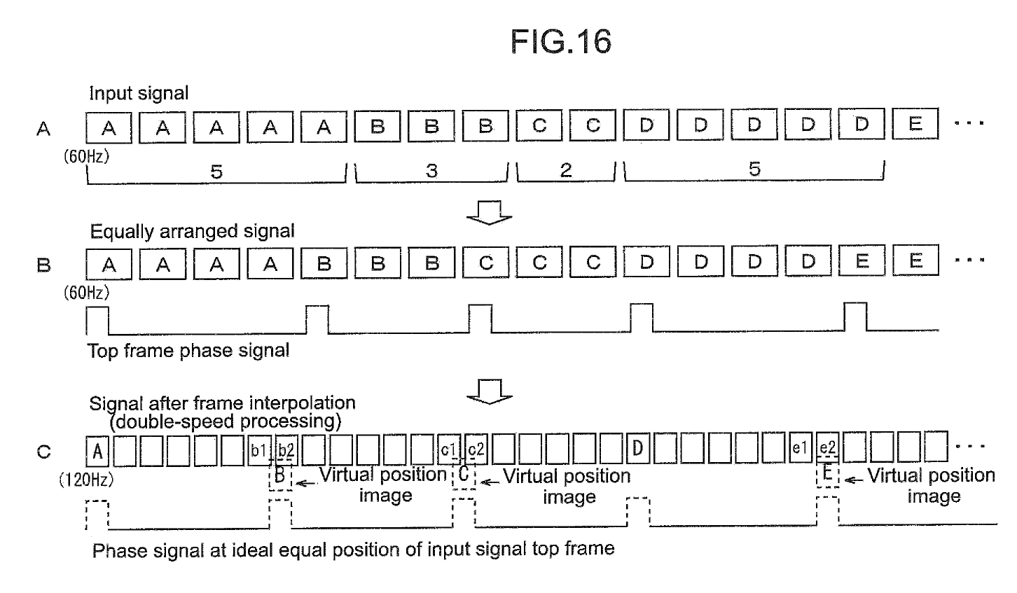

Moreover, for example, as shown in A of FIG. 16, when the conversion unit 161 receives the image signal of the 5-3-2 irregular sequences from outside, the conversion unit 161 converts it to the image signal of the 4-3-3 regular sequences as shown in B of FIG. 16 and detects the corresponding top frame phase signal.

Then, as shown in C of FIG. 16, the frame interpolation unit 162 changes the projections represented by the top frame phase signal from the conversion unit 161 to the equal intervals and performs the frame interpolation to the projections based on the changed top frame phase signal.

Description of Operation of Image Processing Apparatus 141

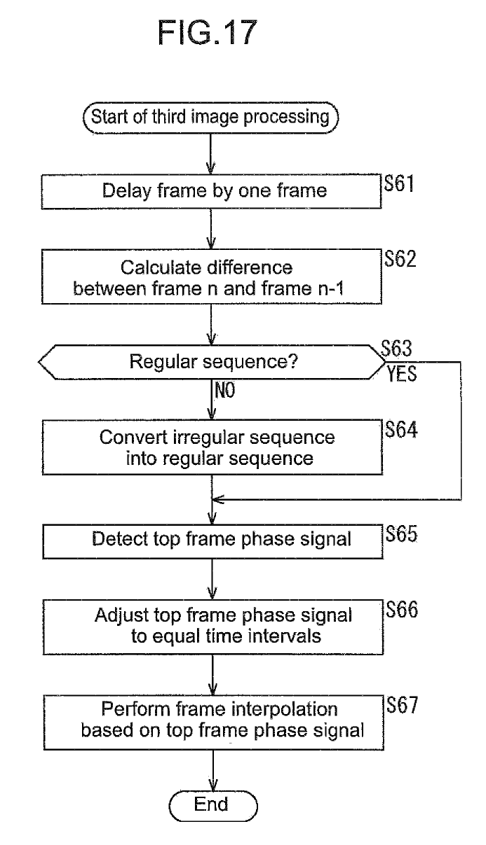

Next, with reference to the flowchart in FIG. 17, the image processing (hereinafter referred to as third image processing) performed by the image processing apparatus 141 will be described.

Herein, the third image processing is started when the image processing apparatus 141 receives the image signal from outside, for example.

In steps S61 to S64, processing similar to that of steps S41 to S44 in FIG. 11 is conducted.

Herein, step S65 is conducted after step S64 or when the appearance pattern of the image signal to be inputted is determined to be the regular sequence in step S63.

In step S65, the conversion unit 161 detects the top frame phase signal based on the image signal outputted from the conversion unit 161 and supplies it to the frame interpolation unit 162 in synchronization with the image signal of the regular sequence obtained by the processing in step S64 or the image signal of the regular sequence from outside.

In step S66, the frame interpolation unit 162 adjusts the top frame phase signal from the conversion unit 161 and changes timings (projections) represented by the top frame phase signal to equal intervals.

In step S67, the frame interpolation unit 162 determines the position of the object on each of the frames constituting the image signal newly generated by the frame interpolation and the like based on the adjusted top frame phase signal. Then, the frame interpolation unit 162 generates and outputs the new image signal constituted of each frame on which the object is drawn at the determined position.

Herein, for example, the third image processing is completed when the image signal inputted into the image processing apparatus 141 is subjected to the image processing and all the frames constituting the image signal obtained by the image processing are outputted.

As described above, according to the third image processing, the frame is interpolated based on the top frame phase signal in which the timings represented by the top frame phase signal are changed to the equal intervals. Therefore, it is possible to make the movement of the object on each of the frames constituting the image signal smoother without the judder.

### 4. Modified Examples

In the first embodiment to third embodiment, when the appearance pattern of the image signal to be inputted is the irregular sequence, the image processing for the irregular sequence (for example, conversion of the irregular sequence into the regular sequence in the second embodiment) is performed.

However, for example, when the image signal whose appearance pattern is the irregular sequence is inputted as a so-called test pattern, it is desirable to temporarily turn off each function for performing the image processing for the irregular sequence.

Therefore, the operation unit 45 provided in the image processing apparatuses 21, 61, 101, 141 and the like may turn each function on or off.

Specifically, for example, a first operation mode to a third operation mode are prepared and the operation modes may be changed in accordance with the user operation to the operation unit 45.

Herein, for example, the first operation mode corresponds to contents described with the first embodiment and is the operation mode in which the IP conversion, the resolution creation processing, the noise reduction processing and the like are performed in accordance with whether or not the appearance pattern of the image signal to be inputted is the regular sequence.

Moreover, for example, the second operation mode corresponds to contents described with the second embodiment and is the operation mode in which when the image signal of irregular sequence is inputted, the image signal of the irregular sequence is converted into the image signal of the regular sequence and the image processing for the regular sequence is performed.

Further, for example, the third operation mode corresponds to contents described with the third embodiment and is the operation mode in which the image processing also includes processing for generating the image signal of the high frame rate based on the top frame phase signal in addition to the contents of the second operation mode.

Herein, the image processing apparatuses 21, 61, 101, and 141 can be made to function as a television receiver, a hard disk recorder, and the like.

Moreover, the present disclosure can be configured as follows.

(1) An image processing apparatus that performs image processing to an image signal constituted of a plurality of images, including: a determination unit configured to determine whether or not an appearance pattern in which the number of repeats representing the number of sequences of the same image appears among the plurality of images constituting the image signal is a predetermined regular pattern for displaying the image signal; and an image processing unit configured to perform the image processing to the image signal in accordance with a determination result of the determination unit.

(2) The image processing apparatus according to Item (1), further including: a conversion unit configured to convert, in response to a determination result of the determination unit that the appearance pattern is a pattern different from the regular pattern, a first image signal having the different pattern into a second image signal having the regular pattern, in which the image processing unit performs the image processing for the regular pattern to the second image signal.

(3) The image processing apparatus according to Item (2), further including: a detection unit configured to detect a timing signal representing timings at which the same image appears sequentially among the plurality of images constituting the second image signal; and an adjustment unit configured to adjust the timing signal and change intervals between the timings to equal intervals, in which the image processing unit performs, based on the adjusted timing signal, the image processing for generating a third image signal constituted of the plurality of different images from the second image signal.

(4) The image processing apparatus according to Item (3), in which the adjustment unit adjusts the timing signal and changes, to the equal intervals, the intervals between the timings generated within a reproduction time for reproducing the second image signal.

(5) The image processing apparatus according to Item (2), in which the conversion unit converts the first image signal into the second image signal in accordance with a conversion rule based on the appearance pattern.

(6) The image processing apparatus according to Item (1), in which the image processing unit performs, as the image processing, at least one of IP conversion processing of converting an interlaced image into a progressive image, noise reduction processing of reducing noise generated in the image, resolution creation processing of converting an image resolution into a higher resolution, and interpolation processing of interpolating a new image to the image signal.

It should be noted that the series of processing described above may be performed by hardware or may be performed by software. When the series of processing is performed by software, programs constituting the software are installed from a program recording medium into a computer incorporated in dedicated hardware or into a general-purpose computer capable of installing various programs to execute various functions, for example.

### Configuration Example of Computer

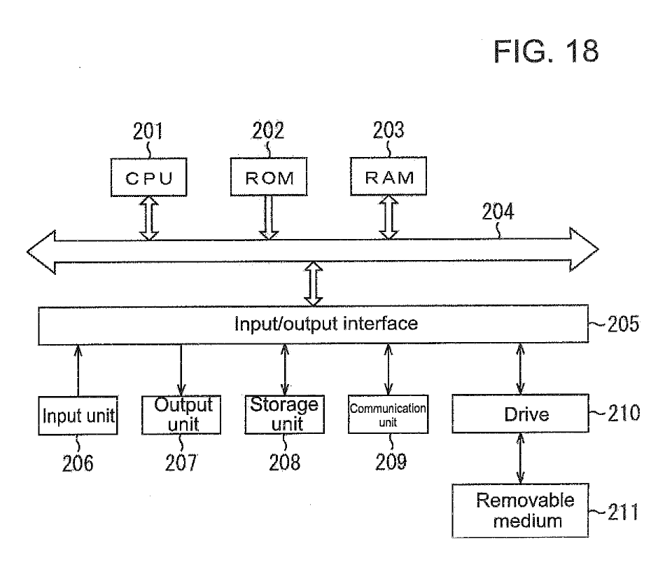

FIG. 18 is a block diagram showing a configuration example of the hardware of the computer for carrying out the series of processing described above with the programs.

A central processing unit (CPU) 201 executes various processing in accordance with a program stored in a Read Only Memory (ROM) 202 or a storage unit 208. A program to be executed by the CPU 201, data and the like are suitably stored into a Random Access Memory (RAM) 203. The CPU 201, the ROM 202 and the RAM 203 are connected to one another by a bus 204.

Also, an input/output interface 205 is connected to the CPU 201 through the bus 204. An input unit 206 including a keyboard, a mouse, a microphone and the like and an output unit 207 including a display unit, a speaker and the like are connected to the input/output interface 205. The CPU 201 executes various processing in accordance with an instruction inputted from the input unit 206. Then, the CPU 201 outputs a result of the processing to the output unit 207.

The storage unit 208 connected to the input/output interface 205 is constituted, for example, of a hard disk and stores a program to be executed by the CPU 201 and various data. A communication unit 209 communicates with an external apparatus connected thereto through a network such as the Internet and/or a local area network.

A program may be acquired through the communication unit 209 and stored into the storage unit 208.

A drive 210 is connected to the input/output interface 205. When a removable medium 211 such as a magnetic disk, an optical disc, a magneto-optical disc, a semiconductor memory or the like is loaded into the drive 210, the drive 210 drives the removable medium 211. Thereupon, the drive 210 acquires a program, data and the like recorded on the removable medium 211. The acquired program or data are transferred to and stored into the storage unit 208 as occasion demands.

The program recording medium on which a program to be installed into a computer and placed into an executable condition by the computer is recorded (stored) may be, for example, as shown in FIG. 18, a removable medium 211 in the form of a package medium constituted of a magnetic disk (including a flexible disk), an optical disc (including a CD-ROM (Compact Disc-Read Only Memory) and a DVD (Digital Versatile Disc)), a magneto-optical disc (including an MD (Mini-Disc)), or a semiconductor memory or may be constituted of the ROM 202, a hard disk included in the storage unit 208 or the like in which the program is stored temporarily or permanently. Recording of the program on the program recording medium is carried out, as occasion demands, through the communication unit 209 which is an interface such as a router and a modem, making use of a wired or wireless communication medium such as a local area network, the Internet and a digital satellite broadcast.

It should be noted that, in the present specification, the steps which describe the series of processing described above may be but need not necessarily be processed in a time series in the order described above, and include processing executed in parallel or individually without being processed in a time series.

Further, the present disclosure is not limited to the first to third embodiments described hereinabove, and variable alterations and modifications can be made without departing from the spirit and scope of the present disclosure.

The present disclosure contains subject matter related to that disclosed in Japanese Priority Patent Application JP 2011-126404 filed in the Japan Patent Office on Jun. 6, 2011, the entire content of which is hereby incorporated by reference.

What is claimed is:

1. An image processing apparatus that performs image processing to an image signal constituted of a plurality of images, comprising:
a determination unit configured to determine whether or not an appearance pattern in which the number of repeats representing the number of sequences of the same image appears among the plurality of images constituting the image signal is a predetermined regular pattern for displaying the image signal; and
an image processing unit configured to perform the image processing to the image signal in accordance with a determination result of the determination unit.

2. The image processing apparatus according to claim 1, further comprising:
a conversion unit configured to convert, in response to a determination result of the determination unit that the appearance pattern is a pattern different from the regular pattern, a first image signal having the different pattern into a second image signal having the regular pattern, wherein
the image processing unit performs the image processing for the regular pattern to the second image signal.

3. The image processing apparatus according to claim 2, further comprising:
a detection unit configured to detect a timing signal representing timings at which the same image appears sequentially among the plurality of images constituting the second image signal; and
an adjustment unit configured to adjust the timing signal and change intervals between the timings to equal intervals, wherein
the image processing unit performs, based on the adjusted timing signal, the image processing for generating a third image signal constituted of the plurality of different images from the second image signal.

4. The image processing apparatus according to claim 3, wherein
the adjustment unit adjusts the timing signal and changes, to the equal intervals, the intervals between the timings generated within a reproduction time for reproducing the second image signal.

5. The image processing apparatus according to claim 2, wherein
the conversion unit converts the first image signal into the second image signal in accordance with a conversion rule based on the appearance pattern.

6. The image processing apparatus according to claim 1, wherein
the image processing unit performs, as the image processing, at least one of IP conversion processing of converting an interlaced image into a progressive image, noise reduction processing of reducing noise generated in the image, resolution creation processing of converting an image resolution into a higher resolution, and interpolation processing of interpolating a new image to the image signal.

7. An image processing method of an image processing apparatus that performs image processing to an image signal constituted of a plurality of images, the method comprising:
by the image processing apparatus,
determining whether or not an appearance pattern in which the number of repeats representing the number of sequences of the same image appears among the plurality of images constituting the image signal is a predetermined regular pattern for displaying the image signal; and
performing the image processing to the image signal in accordance with a determination result of the determining.

8. A program that causes a computer of an image processing apparatus that performs image processing to an image signal constituted of a plurality of images to function as:
a determination unit configured to determine whether or not an appearance pattern in which the number of repeats representing the number of sequences of the same image appears among the plurality of images constituting the image signal is a predetermined regular pattern for displaying the image signal; and
an image processing unit configured to perform the image processing to the image signal in accordance with a determination result of the determination unit.
